(19) United States
(12) Patent Application Publication
(10) Pub. No.: US 2022/0300968 A1
(43) Pub. Date: Sep. 22, 2022

(54) DIGITAL PAYMENT SYSTEM

(71) Applicant: Conferma Limited, Cheadle (GB)

(72) Inventor: Stuart Davenport, Cheadle (GB)

(73) Assignee: Conferma Limited, Cheadle (GB)

(21) Appl. No.: 17/833,785

(22) Filed: Jun. 6, 2022

Related U.S. Application Data
(63) Continuation-in-part of application No. PCT/EP2020/085116, filed on Dec. 8, 2020.

(30) Foreign Application Priority Data
Dec. 9, 2019 (GB) 1918017.3

(51) Int. Cl. G06Q 20/40; G06Q 20/02

(52) U.S. Cl. CPC G06Q 20/401; G06Q 20/02

(57) ABSTRACT

A method of processing a transaction in a digital network uses data strings to identify parties, the data strings having a prescribed format comprising first, second and third data fields and a checksum, whereby the value of first data field identifies an accrediting entity; the value of the second data field identifies an issuing entity acting as a settlement proxy for a customer; the value of the third data field identifies a customer; and the value of the checksum establishes the integrity of the data string.

### BACKGROUND TO THE INVENTION

### 1. Field of the Invention

The present invention relates to the technology and implementation of digital retail payment and reconciliation methods.

### 2. Background of the Invention

Recent developments in such technologies have resulted in an increase in payment systems and methods of implementing those payment systems. Various of these are discussed and identified as forming part of the state of the art below.

### SUMMARY OF THE INVENTION

The present invention provides a new digital processing protocol which may be used for the purpose of implementing, amongst other things, a novel digital payment architecture. Aspects of the present invention are set out in the claims.

An embodiment of the present invention provides a method of processing a transaction in a digital network using data strings to identify parties, the data strings having a prescribed format comprising first, second and third data fields and a checksum, whereby the value of first data field identifies an accrediting entity; the value of the second data field identifies an issuing entity acting as a settlement proxy for a customer; the value of the third data field identifies a customer; and the value of the checksum establishes the integrity of the data string, the method comprising the steps of: providing a primary data string to a customer; assigning an address space within the third data field for use by a further party acting with the authority of the customer, such that (i) all third data values within the assigned address space are available for use in creating valid data strings and (ii) valid data strings having third data values which lie within the designated address space are subordinate data strings to the primary data string within a data hierarchy; establishing constraints subject to which transactions using a given subordinate data string may be conducted and identifying to the accrediting agency, by reference to a range of values lying within the assigned address space, a location within the network of those transaction constraints; requesting a token having the prescribed data format and a valid checksum from the accrediting entity by submitting a token request that includes the given subordinate data string; parsing the token request to identify the given subordinate data string and the location of the transaction constraints; requesting the transaction constraints from the location and storing them at the accrediting entity; and receiving at the accrediting entity, a request for authorisation of a transaction, the request including the token and data expressing conditions of the requested transaction; comparing the transaction conditions to the transaction constraints and, where the conditions lie within the constraints, passing the transaction request to the issuing entity.

### BRIEF DESCRIPTION OF DRAWINGS

Embodiments, both of the present invention and various aspects of the prior art, will now be described, by way of example, and with reference to the accompanying drawings, in which:

FIG. 1 is a schematic illustration of the parties to a standard payment card transaction;

FIG. 2 is a schematic illustration of the role of a Card Account Management System in a modification of the transaction of FIG. 1;

FIG. 3 is a schematic illustration of a detail of FIG. 2;

FIG. 4 is a schematic illustration of the organisation of data held by the Card Issuer;

FIG. 5 is a schematic illustration of the approval and provisioning of a VCN;

FIG. 6 is a schematic illustration of a transaction authorisation process using DPAN or VCN;

FIG. 7 is a schematic illustration of the approval and provisioning of a DPAN from a PAN;

FIG. 8 is a schematic illustration of the approval and provisioning of a DPAN from either a PAN or a VCN; and

FIG. 9 is a schematic representation of a machine according to an example.

### DESCRIPTION OF PREFERRED EMBODIMENTS

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein. As used herein, the term technique comprises an action or procedure that is used as part of a process to achieve a certain objective or tactic.

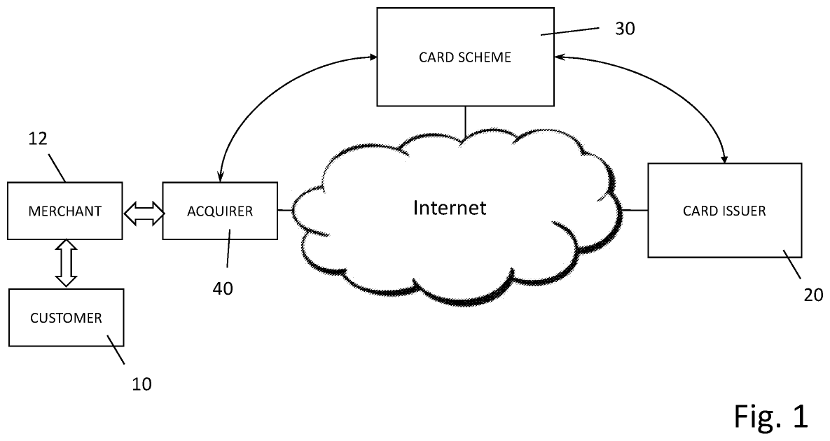

An understanding of the basic technology platform underpinning all bank-based digital retail payments is a useful starting point. Accordingly, reference will now be made to FIG. 1 in which the architecture of current retail payment transaction is set out.

The first party in any transaction is the Customer 10, who will purchase goods or services from a Merchant 12. The payment will be made by the Customer 10 to the Merchant 12 using a card. The card is not money or any other means of exchange per se. Rather, the card is a record of a data string, which in the present example is a number. The data string has a prescribed format which includes four data fields, or elements of data. The values of the data in those data fields identify different entities within the network, also known as parties. The data string can be used to secure the transfer of money, digitally, to a bank account specified by the Merchant 12; with that transfer taking place either quasi-contemporaneously upon conclusion of the sale by the Merchant, or within a relatively short time of it. The technical processes by means of which those data are used to achieve this involve several additional entities, all of whom are third parties to the transaction.

The first of these third parties is the card issuing entity, in the present example, Card Issuer 20. This is the entity by whom the card was given to the Customer 10 as well as being the entity which provides the funds paid to the Merchant 10. To the extent that the Card Issuer 20 makes payment on behalf of the Customer, it acts as a proxy for the Customer's payment role within the course of a transaction. One example of such a card issuer would be the Customer's bank but this is not necessarily the case. Accordingly, one of the data fields recorded on the card necessarily identifies the Card Issuer 20 in order that a request for payment from the Merchant can be properly directed. The value of a further data field on the card identifies the Customer which data is of course required in order for the Card Issuer to log the transaction and disbursement of funds to the Merchant against the person from whom the Card Issuer must recover those funds.

A further intermediate party is an accrediting entity, in the present example the accrediting entity is known as the Card Scheme 30. The Card Scheme entity 30 sits between the Card Issuer 20 and the Merchant 12. One practical role of the Card Scheme is to provide the Merchant with a degree of trust and confidence that a card presented by a Customer 10 is one that will ultimately result in the Merchant 12 receiving the requisite funds. For example, there are many Card Issuers and new issuers appear all the time. It is, therefore, by no means necessarily the case that a particular Card Issuer 20 will be known or even known at all to the Merchant 12. Where a card carries the symbol (and other signifying data) of a recognised Card Scheme, the Merchant 12 can have confidence that the Card Issuer 20 is accredited by the Card Scheme 30 and that, accordingly, the data on the card presented by the Customer is authentic and will result in the provision of the funds due to the Merchant pursuant to the transaction.

One prescribed format of card data, and thus the information that can be obtained by parsing that data format is set out below for a data string ABCD EFGH IJKL MNO . . . P. In the present example all of the data values in the string are arabic numerals 0-9. The ellipses between the penultimate data value and the final data value signify a wildcard which is a placeholder for zero to three additional numbers. The prescribed format has four data fields and a complete data string with all four fields is illustrate below.

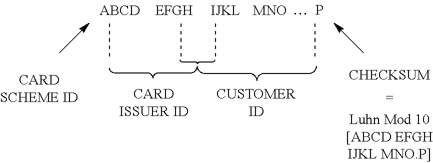

The complete data string, which in the present example is a number of between 16 and 19 digits, is known as the card number. That data string, in the form of the Card Number is a primary data string associated with the customer. In the present example the primacy of that data string arises from the card number also signifying a payment account which the card bearer has with a Card Issuer, known also as the Primary Account Number or PAN. The four data fields are explained below:
The first data field is the first character. The value of the first character, which in the present example is a digit, identifies the accrediting entity, that is to say the card scheme. For example, “3” signifies Amex and Diners Club; “4” signifies VISA; and “5” signifies Mastercard
The second data field is 6 to 8 characters long, and again in the present example those characters are numbers. The value of the second data field identifies the card issuing entity which acts as a proxy settlement entity to the accrediting entity. In the present embodiment the proxy settlement entity is the Card Issuer
The third data field is 6-8^{th} to the 15-18^{th} characters and again in the present example the third data field consists of numbers. The value of the third data field identifies the Card Holder (Customer) to the Card Issuer
The fourth and final data field is one character. Once again that character is a number. In the present example the number is a checksum whose value validates the integrity of the data string as a whole. In the present example the checksum is calculated according to an algorithm known as ‘Luhn Mod 10’

When the data recorded on the card is presented to the Merchant, it is used in connection with the following sequence of events, each of which is required in order for the transaction to conclude.
1. In circumstances in which the transaction is established with the Merchant 12 by the presentation of the physical card, the credentials stored (in encrypted form) on the card are used to enable the Customer 10 to authenticate themself as the rightful holder of the card which they have presented to the Merchant. The encrypted credentials held on the card are used to create a “challenge-response” authentication—typically requiring the Customer to enter a PIN. Where the transaction is undertaken without the card being presented—known as a ‘Card Not Present’ transaction, this step cannot be performed. Authentication is typically performed by the presentation, by the customer, of a separate character string on the back of the card. This is a less secure form of authentication as a third party who has had sight of the card for moments can submit this data.
2. The values of the data fields on the card must be parsed to enable routing of the payment request from the Merchant 12 for payment to the relevant Card Scheme. To this end, the value of the first data field (this being the first digit) is used to establish the card scheme as discussed above.
3. The value of the second data field must be parsed by the Card Scheme to identify the Card Issuer to which it must forward the request for payment. This is done using the next 6 to 8 digits on the card, which are known as the Issuer Identification Number.
4. The value of the third data field must enable the Card Issuer to identify the Customer so that Card Issuer can debit the funds it is required to pay against the Customer's account with the Card Issuer. The Customer is identified to the Card Issuer by the remaining digits of the card number (save for the final digit which is a checksum).

For transactions in which the physical card is presented, the data recorded on the card must be machine readable and transmissible. This requires hardware infrastructure which is both capable of: machine reading relevant encrypted data and which is trusted by the Merchant accurately to read that data; and machine reading the various identification data and incorporating it into the relevant format of data packets transmissible over a network, first to the Card Scheme, and some of which are then forwarded to the Card Issuer. That infrastructure is provided by yet another intermediate party, the Acquirer 40, which mediates between the Card Scheme and the Merchant.

A number of modifications to this basic payment architecture have arisen in recent years. These provide additional functionality for certain categories of user, as well as providing additional flexibility in the conduct of transactions which are undertaken in circumstances where the physical payment card is not present, known as Card Not Present (CNP) transactions.

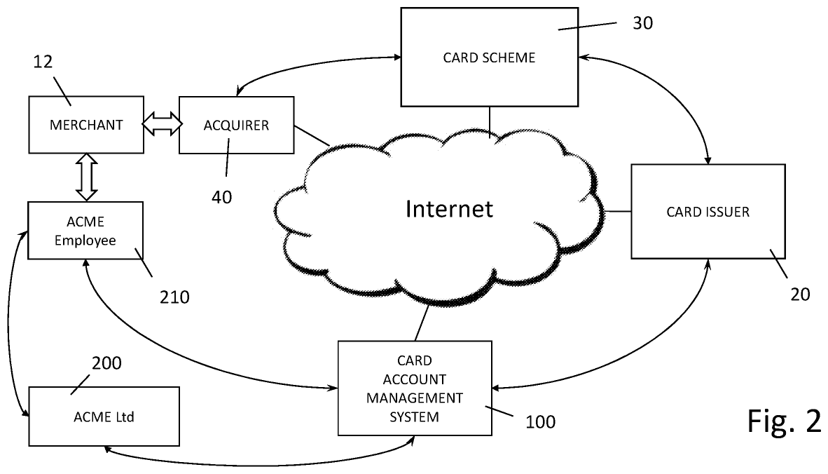

Referring now additionally to FIG. 2, the first of these modifications relates to a circumstance which a corporate entity 200, Acme Ltd wishes to provide several of its employees 210 with the capacity to make payments using cards whereby those payments are each then debited to the PAN associated by the Card Issuer 20 with Acme. A superficially attractive solution would be for Acme to request that the Card Issuer provide each of its employees with a card carrying the number of its PAN, meaning that all of the employees 210 carry cards with the same number. This has many drawbacks. Different, and potentially simultaneous transactions could be performed with identical card numbers at different locations meaning that it is not possible to provide any data concerning the identity of the employee performing the transaction on Acme's behalf. That, in turn, means that, for example in the event of unauthorised spending, Acme has no way of establishing which employee was responsible. Relatedly, fraudulent spending by third parties is correspondingly more difficult to identify. The solution to the problem is the issue to employees 210 of cards in the role of authorised account user. Each such employee receives a ‘user card’ which has a unique number and therefore has the appearance of a normal card. However, each such user card does not signify a corresponding PAN. Instead, all of the user cards are linked by the Card Issuer 20 to a single PAN: Acme's PAN. Typically this is done by the Card Issuer 20 assigning a certain defined number address space within the third data field and then pointing the entire assigned address space to the Acme PAN. Expressed another way, the primary data string, namely the PAN, is a parent data string in a data hierarchy and all card numbers (data strings) which include data values within the third data field that lie within the assigned address space are in a lower or subordinate data hierarchical level to the primary data string. Thus, whilst the numbers of user cards will be recognised by the Card Issuer as related to a predetermined PAN—in the present example that of Acme Ltd—they are not numbers which themselves signify any PAN. By means of the use of user cards, all spending undertaken by of Acme employees on user cards is debited to the single Acme PAN; but nonetheless appears on the ledger of the Acme PAN against the unique user card number which was presented in connection with the relevant transaction which therefore enables Acme to establish what each of its employees spent.

Large corporate entities such as Acme 200 have found that managing the issue of user cards and the accounting tasks associated with them to be burdensome. This has given rise to the provision of a trusted administrator, which is a third party acting for ACME 200, and providing a Card Account Management service (CAMS) 100. The CAMS 100 manages the provision of cards to employees as well as the accounting of spending by them so that Acme is presented with a single invoice to settle with the Card Issuer 20 regardless of the number of employee transactions have taken place.

The CAMS, being a service dedicated to this function, has further established a number of developments and refinements to the traditional user card model which entities such as Acme have found to be useful and attractive to them. The first of these is the provision of what are termed ‘Virtual Card Numbers’ (VCNs) to employees. VCNs are numbers which operate just as the numbers of user cards. These VCNs have authentic number formats which therefore may be parsed by the Acquirer 40 to identify the Card Scheme 30 and Card Issuer 20 in the manner set out above, and using an pre-determined range of address space within the overall numbering estate assigned Acme. To this extent, VCNs are logically the same as user cards and so a VCN is a form of user card number. However, in the case of a VCN no physical card recording the VCN is ever minted, hence they are regarded as ‘virtual’.

One principal reason for this is that VCNs are designed to be of an essentially ephemeral character. Thus, they are provided to employees in connection with far more specifically defined purposes and are therefore remain valid for the performance of transactions typically only for a relatively limited period of time, with a restricted credit limit and restricted by limitation to category of merchant. The provision of restricted conditions upon the use of VCNs greatly reduces Acme's exposure to fraud or unauthorised spending by a careless or rogue employee. Provision of VCNs to employees 210, including authentication to establish an employees entitlement to a VCN as well as the provisioning of various payment authorisation conditions applying in connection with provided VCNs is all managed by the CAMS 100.

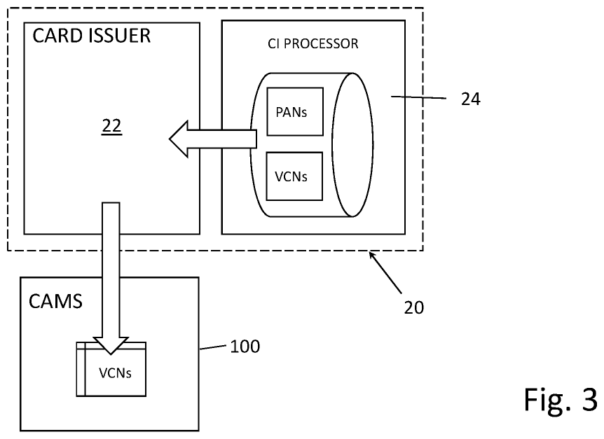

There are a variety of ways in which VCNs may be provided to employees via the CAMS 100. However, before these are discussed in detail, it is first necessary to amplify certain aspects of the operation of the Card Issuer 20. The first of these is schematically illustrated in FIG. 3. The Card Issuer 20 is represented in FIGS. 1 and 2 as a single logical card issuing entity. In reality, it usually comprises at least two legal entities: the card issuing company 22 (often, though not always a bank) and a CI Processor 24 which provides utility computing facilities to the card issuing company 22 and importantly, as part of those services, storage of data, in particular card number and related data. One prevalent element of the operation of the Card Issuer 20 is that the issuing company 22 is typically charged what can be thought of as a ‘rental’ fee for the storage of credit card numbers (and related data) by the processor 24. Typically that fee is levied on the basis of a specified sum of money per card number stored over a defined time interval.

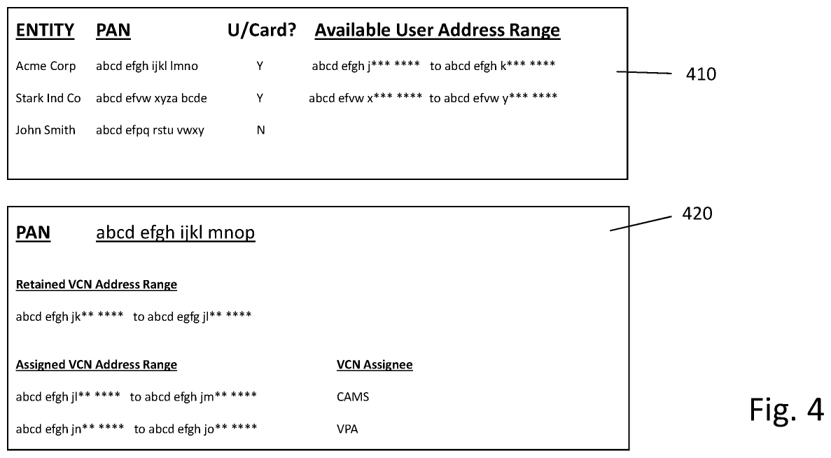

The organisation and assignment of various address spaces within the numbering estate provided for use as user card numbers such as VCNs will now be discussed in connection with FIG. 4, which provides a schematic illustration of the retention and logical organisation of card numbers by the Card Issuer 20. Table 410 illustrates the retention by the Card Issuer of a ledger of customer identities against their respective PAN. Thus, ACME Corp is recorded as the identity of the Customer 200 and against which ACME's PAN is recorded. The next data field is one which establishes whether the identified customer has a user card facility available to it—i.e. whether the customer has requested the capability of having user cards issued to third parties (employees of ACME, or in the case of a customer who is an individual, family members for example) which are then linked to, and spending on them debited against, the customer's PAN. The data filed is demonstrated by the heading “U/Card?” and the “Y” in this column of the table indicates that ACME has this facility. Where the entry in the U/Card? field is positive, the subsequent data filed records the range of numbering address space which has been made available by the for the issue of user cards for the Customer in question. Thus, from the table it can be seen that ACME Corp PAN is abcd efgh ijkl lmno. The Card Issuer 20 has reserved the address space abcd efgh j*** **** to abcd efgh k*** **** for the issue of user cards linked to the ACME PAN. Thus, it follows that ACME has the capacity to issue up to 10,000,000 user cards linked to its PAN. Practically speaking this is a far greater size of address space than that which would usually be allocated for user cards.

Table 420 displays data fields and related data that concern the management of the address space available for the issue of ACME user cards. Thus, the illustrative table shows that the Card Issuer has designated the 1,000,000 user card numbers in the range abcd efgh j k** **** to abcd egfg jl** **** for use as VCNs which it will retain direct control of. Two other ranges are indicated as having been reserved to third parties—which means, at a minimum, that the Card Issuer 20 will not itself issue user cards in those ranges. Thus, the 1,000,000 numbers in the range abcd efgh jl** **** to abcd efgh jm** **** are designated as being reserved to the CAMS. In the present embodiment, this occurs by the Card Issuer 20 actually providing those numbers to the CAMS (for the purpose of their provision to employees 210—though practically speaking this is a matter for the CAMS and once the Card Issuer has provided those numbers it has effectively no control over whom they're issued to) whilst the 1,000,000 numbers in the range abcd efgh jn** **** to abcd efgh jo** **** have been reserved for use by a service, one commercial example of which is known as VPA, whose function and purpose will be discussed subsequently.

Turning now to the provision of VCNs by the CAMS 100 to employees 210, in the first mode of VCN provision, the Card Issuer 20 simply sends a defined quantity of VCNs. In the illustration set out above, the Card Issuer 20 has 1,000,000 VCN numbers from the ACME Corp address space available to send to the CAMS. Typically, however, by way of example to provide some idea as to the scale of numbers involved, the Card Issuer 20 will send around 10,000 VCNs to the CAMS. These are then stored by the CAMS 100 (illustrated schematically in FIG. 3) to enable the CAMS then to provide VCNs to employees 210, whilst the Card Scheme 30 is also notified by the Card Issuer of the numbering range which has been provided to the CAMS 100. This enables the Card Scheme subsequently to identify a payment authorisation request which originates in respect of a VCN provisioned by the CAMS 100.

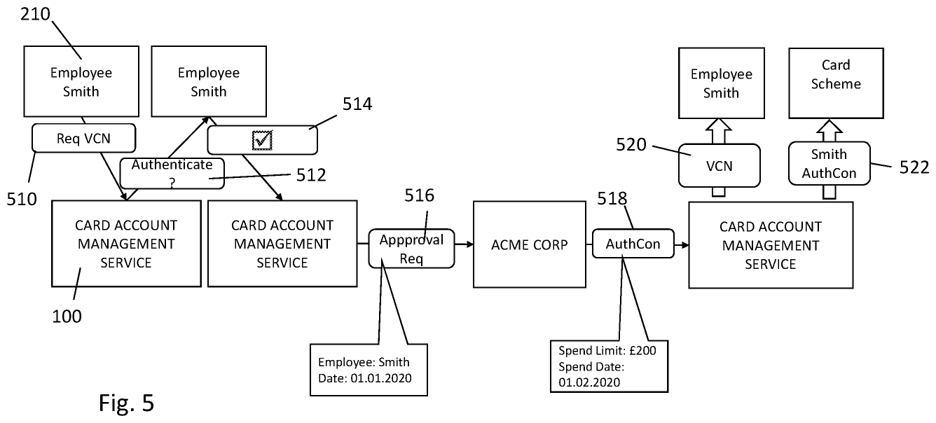

The provision of VCNs to employees is illustrated schematically with reference to FIG. 5. An employee 210, Smith, of ACME Corp requests a VCN from the CAMS 100, at step 510. Upon receipt of this request the CAMS 100 then issues an authentication challenge to the employee at step 512. The response to the authentication challenge is sent by the employee at 514. Where this response authenticates the employee 210, at step 516 the CAMS 100 then contacts ACME to request from ACME any transaction constraints which ACME wishes to impose upon its provision of a VCN to employee Smith as well as upon payment using that individual VCN. At step 518 ACME then send those transaction constraints (which may also be thought of as authorisation conditions, since they are the conditions upon which authorisation for the provision of a VCN is granted) to the CAMS 100.

An example of authorisation conditions are a spending limit of £200 and transactions to be made only in 1 Feb. 2020. Upon receipt of the payment authorisation conditions, the CAMS 100 then sends the VCN to employee Smith at step 520 and the payment authorisation conditions to the Card Scheme 30 at step 522.

Further examples of typical payment authorisation conditions are limitations on the use of the VCN; for example, limitation to use of the VCN in a single specified transaction; limitation to use in a transaction of a defined value; or use in a single group of transactions sharing a common, defined characteristic. Examples of such transactions might be for payment of a hotel or a flight; or, alternatively, payment of for both of those events, together with payment of taxi and food expenses at a defined location and up to a defined aggregate value. When employee Smith of ACME presents the VCN to provide funds for a transaction, details of the transaction (Merchant identity, transaction value, date and potentially other details in addition), are transmitted by the Acquirer in the ordinary course of events, to the Card Scheme and, in some embodiments, then on to the Card Issuer 20. Payment of the funds is only authorised if the transaction conditions are consistent with the payment authorizing conditions. Essentially, therefore, those authorizing conditions can be thought of as constraints on allowable transactions permissible with a given VCN which are placed upon transactions presented by reference to that VCN.

The precise characteristics of the authorizing conditions are effectively enforced in one of two ways. First, the authorizing conditions may be shared by the CAMS with the Card Issuer which are then retained by the Card Issuer in a manner which links them to the VCN to which they relate. Alternatively, and as illustrated in FIG. 5, those authorizing conditions can be sent to the Card Scheme 30 by the CAMS 100 for the Card Scheme 30 to implement via processing in a dedicated payment channel. For example, in the case of the VISA card scheme, a process known as Visa Payables Automation (VPA) operates to enforce the various authorisation conditions provided to it by the CAMS upon payment requests received from Merchants arising in connection with the presentation of a VCN. VPA is used here for illustration. Any service performing the same task can be deployed and by way of other real world examples, similar channels are available for other card schemes, for example Mastercard having the Mastercard InControl).

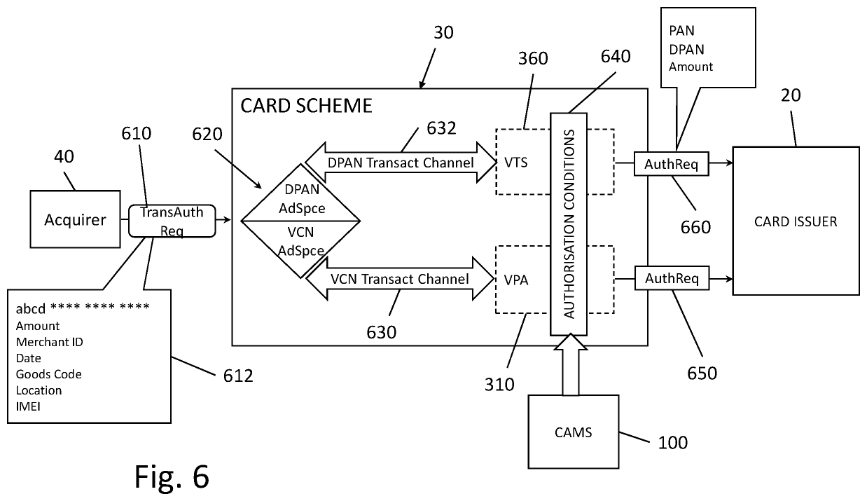

This operation will now be described in more detail with reference to the schematic representation in FIG. 6. The initial parsing of payment authorisation request 610 transmitted from the Acquirer 40 at process decision 620 establishes, on the basis of specified number range which it recognises as constituting a VCN originating from the CAMS, that the request should be routed along the VCN transaction channel 630 so that the VPA service 310 of the Card Scheme 30 is invoked to process the payment authorisation request 610. The VPA 310 is provided with authorisation conditions 640 from the CAMS 100. The authorisation conditions 640 are constraints upon the conditions of transactions which operate to filter out unauthorised payment requests made in respect of a given VCN; only those payment requests that meet the authorisation conditions are passed to the Card Issuer 20, with those that do not being declined by the Card Scheme without being forwarded. It is to be noted that, as a consequence of agreements concluded between the CAMS and the Card Scheme, the CAMS is considered to be a trusted entity to the Card Scheme which enables the provision of those authorisation conditions 640 and their implementation by the Card Scheme 30. Upon authorisation by the Card Issuer 20, the Card Issuer then informs the CAMS 100 of the transaction which the CAMS 100 then records accordingly.

The CAMS then aggregates the various transactions performed under each VCN, mapping them to the identity of the employee in respect of which they have been issued and then provides a full reconciliation of these transactions to the Corporate Entity, which, based upon the ledger provided to it by the CAMS, then provides payment to the Card Issuer.

The benefits of such a payment architecture are manifold. First, the provision of VCNs whose use is linked to and constrained by authorisation conditions restricts the capacity of an employee to embark upon unauthorised spending. Secondly, because each VCN is effectively ephemeral, the vulnerability of the use of that VCN to fraudulent third party activity is substantially reduced.

VCNs are typically managed by the CAMS in one of two ways:
1. Store and Rotate with Static Limits: a fixed number of VCNs are retained by the CAMS. Each VCN is preconfigured with a static credit limit with an always open-to-buy option. The number is typically significantly in excess of the number of VCNs which are in active allocation at any one time. Used VCNs are then moved to the bottom of a circulating list, whose length is such that the time period between consecutive uses of a given VCN is sufficiently long. VCNs are therefore selected from the store in accordance with a simple cab rank rule.
2. Store and Rotate with Dynamic Limits: a fixed number of VCNs are retained by the CAMS. Each VCN is assigned a purchase specific credit limit with a restricted open-to-buy period. The number is typically significantly in excess of the number of VCNs which are in active allocation at any one time. Used VCNs are then moved to the bottom of a circulating list. The length of the list is such that the time period between consecutive uses of a given VCN is sufficiently long that no single VCN ever risks being present in the transaction chain under more than one bearer. VCNs are therefore selected from the store in accordance with a simple cab rank rule.

VCNs may be retained by and managed by the Card Issuer and/or the Card Scheme for or on behalf of the CAMS and, where this is so, they may likewise by managed by either of these entities in either or both of these ways.

A further option for the creation, allocation and management of VCNs arises from a commercial reality elucidated in connection with FIG. 3 above. As mentioned above, the Card Issuing Company 22 incurs ongoing fees to the CI Processor 24 in respect of VCNs retained by the CI Processor 24. It is therefore advantageous to the Card Issuing Company 22 not to retain or store any VCNs. To this end, and referring once again to FIG. 4, the Card Issuer reserves a specified address range (stated in FIG. 4 to be abcd efgh jn** **** to abcd efgh jo** ****) to an external platform. One example of a suitable external platform is VPA. The VPA is then authorised by the Card Issuer 20 to generate numbers in this range for use as VCNs. At this point it should be noted that the VPA is a workflow service is not itself able to generate VCNs. It transfers requests from the CAMS for generated VCNs to a different process (DPAN generation process—though in the industry they are referred to simply as ‘tokens’) within a Card Scheme service known as the VTS to generate the VCNs. (NB Alternative schemes to VISA, such as Mastercard operate differently, such that the Mastercard equivalent of VPA, “InControl”, generates the VCNs). This process will be referred to and contextualized subsequently but is mentioned for completeness at this juncture.

VCNs generated by the Card Scheme are generated for use by the CAMS and, once generated, are sent to the CAMS for allocation to the employee 210. In one mode of operation the VPA 310 manages the generated VCNs in accordance with the “store and rotate with dynamic limits” model described above. This management model is known as “Card Issuer VCN Platform”. Alternatively, the VPA generates, in quasi-real time, a new VCN upon receipt of a request from the CAMS 100 which will then operate in accordance with the payment authorisation conditions set by the CAMS. This management model is known as “Card Scheme Tokenization Platform”.

VCNs are colloquially regarded as ‘tokens’. The reason for this is firstly that, as discussed above, they do not signify the number of a physically minted card; and secondly that each VCN does not represent its own payment account. Whilst this view has some justification it is also to a degree misleading. With regard to the first point, as we have demonstrated above, the physical payment card does no more than act as a store of data by means of which a Merchant, using the infrastructure provided by the Acquirer, may then transmit the relevant data to the relevant entities in the payment architecture in order to receive funds for the transaction. VCNs are parsed to enable the performance of exactly the same processes for exactly the same purpose. Further, from a processing and accounting point of view, user cards operate in the same manner as VCNs. To this extent the existence and use of VCNs differs little from established practices.

There is, however, a difference of critical importance to previous, established practice. First, it is noteworthy and of some importance that two entities in the payment architecture—the Card Issuer and the CAMS—are capable of resolving VCNs to a real, primary card account. However, the CAMS is what might be termed an ‘optional’ entity in the architecture, any entity seeking to reconcile a VCN to a primary card account will refer in the first instance to the Card Issuer, since this is the entity which will always be present and be able to link any given VCN to a primary account number (known as a PAN). The second distinction is of greater significance: although the Card Issuer can link a given VCN to a primary account number, it does not allocate a VCN to an employee 210. Thus, unlike the classical user card situation described above where the bearer of the user card is a nominated individual whose name appears on the card and therefore in connection with the transaction, the Card Issuer has no knowledge of the identity of the bearer of a VCN since this was allocated by the CAMS. Accordingly, the only entity which is capable of resolving a VCN to an individual card user, who, in the example provided, is a given employee of the Corporate Entity, is the CAMS. It is for this reason that, when processing payment authorisations requested in respect of VCNs, the VPA is adapted to receive and apply authorisation conditions 640 provided to it by the CAMS 100.

A further modification to the basic architecture has arisen as a consequence of the use of payment tokens which are now widely accepted in lieu of cards as a means of providing data necessary to conclude the various processes involved in a retail payment transaction. Such tokens are typically carried on (and by virtue of that, to some degree integrated into) mobile devices such as cell phones. One example of this is Apple Pay; another is Samsung Pay. Each of these services are known as Token Requestors (to consumers Digital Wallets).

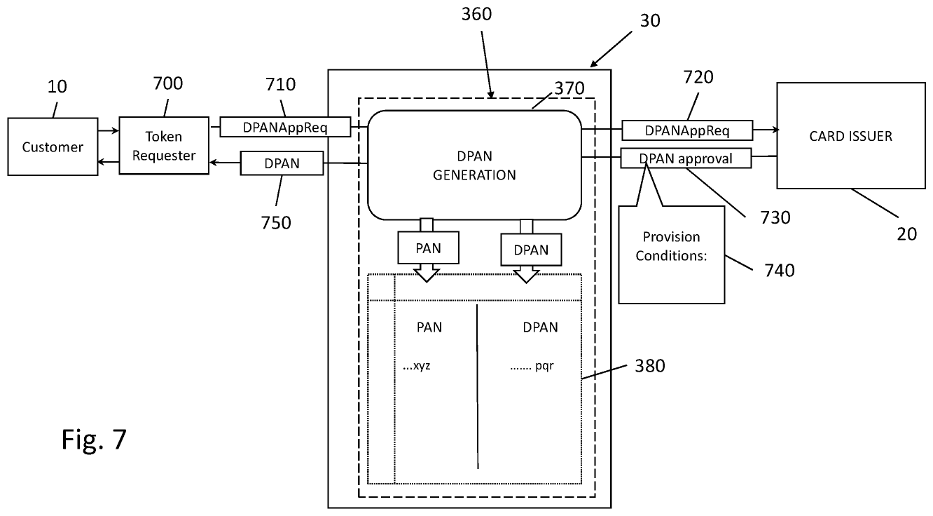

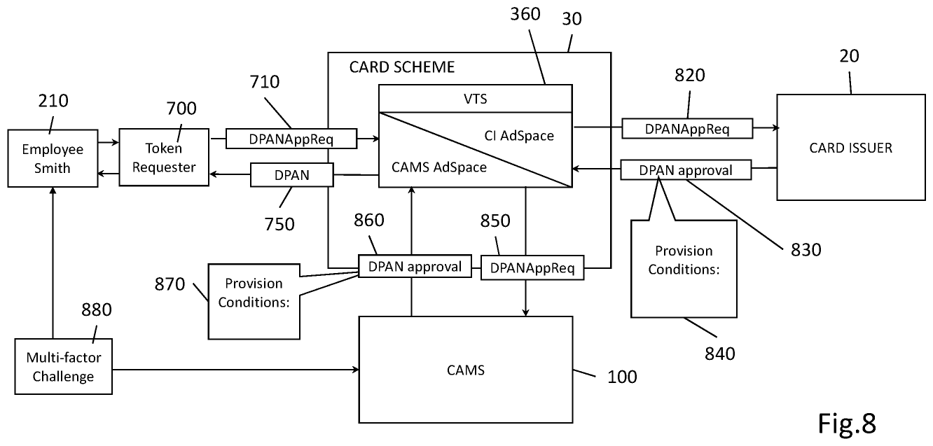

Each of these payment systems functions in substantially the same manner. Referring now to FIG. 7, a requisite for the provision of such a token in each case is that a user of the service must have an existing payment card provided by a Card Issuer. Upon receipt of a request from a customer 10 for enrolment to one of these services, the Token Requestor 700—e.g. Apple or Samsung—requests the number of the payment card held by the requesting customer which it then regards as representing the payment account held by the Card Issuer. Ordinarily, where the request is from an individual, the number borne by the card preferred in respect of the request is the PAN, also known as the Funding Primary Account Number (FPAN). Alternatively, where it is the number of a user card, the link between the user card number and the PAN will be held by the Card Issuer 20. In any event, upon receipt of the card number (which in this instance is also the PAN), the Token Requester sends the request together with the PAN at 710 for approval to the Card Scheme 30. The Card Scheme identifies the request as originating from a Token Requester 700 and invokes a service known, in the case of Visa as the Visa Tokenisation Service (VTS) 360. The VTS performs a number of functions. First and as illustrated in FIG. 7, the VTS forwards, at 720, the request to the Card Issuer 20 for approval. Where the Card Issuer provides approval, at 730, this may be subject to approval conditions 740 which are linked. Upon receipt of approval and as illustrated in FIG. 8, the VTS then invokes a DPAN generation process 370 which is a process that generates a cryptographically generated number known as a Device Primary Account Number, or DPAN. Subsequently, and referring once again to FIG. 8, the VTS stores the DPAN in a ledger 380 against the PAN in respect of which it was created. Finally, the DPAN is sent to the Token Requester 700 at 750 and then onto the Customer 10. The DPAN is unique to the cell phone or other device upon which the number is to be stored and by means of which the number is to be presented to Merchants. The ledger 380 on which the DPAN is stored by the Card Scheme also pairs or maps the DPAN with other data relating to the device upon which the DPAN is carried by the user (one example of which is the IMEI number where the device is a cell phone, for example).

Payment using a DPAN operates in much the same way as a payment using a VCN or a standard payment card number in a Card Not Present transaction. Referring once again to FIG. 6, the DPAN is presented to the Merchant by the Customer using whatever device it is stored on. Transmission of the DPAN from Customer to the on site Acquirer 40 infrastructure held by the Merchant is via one of a number of established physical mechanisms, primary examples of which are by means of near field radio communication (abbreviated to NFC) or a visual symbol which encodes the DPAN, such as a QR code. Because the DPAN has exactly the same number format as a standard payment card number, it is parsed by the Acquirer in exactly the same way as a standard card number and, based on the numbers in the initial part of its address space, routed to the relevant card scheme. In the present example this will be the VISA card scheme. Critically, the Acquirer 40 also sends what can be regarded as payment metadata 612 relating to the transaction as part of the transaction authorisation request 610. This will include, at a minimum, data concerning the device presenting the DPAN, and may also include geolocation data for the transaction.

The Card Scheme parses the numbering in the initial part of the DPAN number address space at process decision 620 to establish that the number it has received is a DPAN. On that basis it then routes the transaction data through its DPAN transaction channel 632 to the VTS. The VTS then performs the following:
a. Reconciliation of the DPAN to the device metadata from which it has been presented, typically referring to data stored within the ledger 380 against the DPAN. If the two do not match then this is indicative of the DPAN having been misappropriated from the device in connection with which the DPAN was issued to the Customer by the payment service and therefore signifies that some fraud may have occurred. In this situation, the VTS will not process the transaction any further and it will be declined
b. applying the authorisation conditions (aka transaction constraints) 640, such that only those payment requests that meet the authorisation conditions are passed to the Card Issuer 20, with those that do not being declined by the VTS 360 of the Card Scheme without being forwarded.
c. Lookup in the ledger of the PAN to which the DPAN is linked
d. only those payment requests that meet the authorisation conditions are passed to the Card Issuer 20, with those that do not being declined by the Card Scheme without being forwarded.
e. Transmission at step 650 to the Card Issuer of a request for authorisation of a payment in a form which provides the following data to the Card Issuer:
   (i) PAN
   (ii) The amount for which authorisation is requested together with details of the Merchant to whom payment should be made
   (iii) The DPAN. This is provided to the Card Issuer in what can be thought of as a ‘payment reference’ field, since the DPAN is not stored by the Card Issuer.
f. The Card Issuer returns authorisation (or a notice declining authorisation) to the VTS, together with the DPAN which serves in some measure as a ‘label’ for the authorisation sent to the VTS, to assist the VTS in identifying the transaction to which the authorisation relates.
g. The DPAN and payment authorisation are then routed back to the Merchant via the Acquirer.

As mentioned above, the DPAN is regarded as a ‘token’. Whilst the DPAN has exactly the same number format as a standard payment card number and is parsed by the Acquirer in precisely the same manner, there is some justification for regarding the DPAN as a token. First, the Card Issuer does not generate the DPAN, it is generated by the VTS in response to a request from the Token Requester, originating from the customer secondly, the Card Issuer does not carry a record of the DPAN; thirdly, the DPAN is generated cryptographically and can be presented only from a single device. It is said by the payment service providers (i.e. Apple and Samsung) that the use of a DPAN protects the real card number (RCN) or PAN to which the DPAN relates. This is correct but only to a degree. The DPAN and transaction protocol using it protects the user against potential misappropriation of the PAN from the device upon which the DPAN is carried. The DPAN data is shared with the Merchant but also a Cryptogram is created (using details from the device). This DPAN and Cryptogram is validated by VTS to confirm the pairing is correct. Thus, if the DPAN is presented in conjunction with different related data then the transaction will be declined; and acquisition of the DPAN on its own will not enable a fraudster to perform any other transaction. However, there exists, as there must, the ledger 380 on which DPANs are mapped to PANs, and were access to that register to be compromised, the DPAN would offer no protection whatsoever because it has in effect been circumvented.

In accordance with an aspect of the present invention, it is a logical evolution of the foregoing that employees of ACME who have been issued with VCNs may wish to use them in conjunction with a Token Requestor (Digital Wallet) service, such as Apple or Samsung pay, since this provides greater convenience. However, this brings with it some significant difficulties which must be overcome.

The process of attempting to obtain a DPAN from a VCN where the relevant data linking the holders of VCNs to the PAN will now be considered. An employee 210 of ACME wishing to obtain a DPAN prefers the VCN previously requested and obtained from the CAMS 100, to the Token Requestor. The Token Requestor parses the VCN and, on the basis of the initial digits, sends the VCN to the relevant Card Scheme. At this point, the Card Scheme identifies the request as originating from a Token Requestor and invokes the VTS. Without more, the VTS would use the numbering estate of the VCN to identify the Card Issuer 20 from whose numbering address space the VCN originates and forward the DPAN approval request to that Card Issuer. It is at this point in the enrolment process that it would founder depending upon the VCN management process adopted. This is explored in more detail below:
Where the VCN belongs to an address space which the Card Issuer has either retained for its own use, or assigned for the use directly by the CAMS, the Card Issuer 20 is both able to identify the PAN to which the VCN is linked and identify that the entity managing that address space for the provision of VCNs is the CAMS. Further, whilst the Card Issuer 20 has no knowledge of the identity of the ACME Employee 210 to whom the VCN was issued, it is aware that the CAMS 100 is managing the VCN in question and so it is theoretically and conceptually possible (though this does not happen in practice) for it to forward the request to the CAMS. In such a theoretic scenario, then CAMS would then enable provision of the various payment authorisation conditions associated with the VCN used to request the DPAN and either transmit those back to the Card Issuer who forwards them to the VTS; or to provide them to the VTS directly. In this way the DPAN request could be approved and provisioned with the necessary payment transaction constraints (authorisation conditions).
Where the VCN belongs to an address space which the Card Issuer has simply reserved for the exclusive use of the Card Scheme, whilst the Card Issuer has sufficient data to link the VCN to a PAN and to establish that the VCN lies in an address space it has assigned for the exclusive use of the Card Scheme, beyond that, it has no data (it is not even aware which numbers within the assigned address space have been generated). The Card Issuer therefore has no knowledge of the particular identity of the Employee to whom the VCN has been issued, nor of the various transaction constraints which were attached to the VCN as the provisioning basis for requesting the DPAN, and which transaction conditions must therefore likewise be attached to the provision of the DPAN if it is to be ensured that the DPAN is to be used subject to the same transaction constraints as those applying to the VCN. Any authorisation provided by the Card Issuer in these circumstances would, therefore, effectively be given ‘blind’.

It is useful at this point to recall that in the VPA transfers requests received by it from the CAMS for the creation of VCNs to the VTS DPAN generation process 370, and that those created VCNs are then returned by the VTS to the VPA and in turn to the CAMS 100. In either of the Card Issuer VCN Platform and Card Scheme Tokenization Platform models the VPA has address space reserved for its use by the Card Issuer. Notification by the Card Issuer to the VPA of this is likewise accompanied by a corresponding notification to the VTS by the CAMS of the address space in which either or both of those VCN management methods are operated by the VPA. This enables the VTS to identify, upon the receipt of a request for the provision of a DPAN, the location within the network to which a provisioning request for transaction constraints should be directed. In the present example that location is identified by reference to the party: the Card Issuer or the CAMS.

Referring now to FIG. 8, an enhanced process for approval requests for DPANS, capable additionally of dealing with requests based on VCNs issued for employees 210 of ACME will now be described.
I A request for approval of a token in the form of a DPAN 710 is received as previously described in connection with FIG. 7. The request includes the data string which is subordinate to the PAN from which it depends, being the VCN.
II On receipt by the VTS, a decision process based on parsing the PAN or VCN is invoked to establish whether the value of the third data field in the data string (PAN or VCN) in connection with which token request has been made lies in the assigned address space reserved by the Card Issuer for the VPA to create VCNs (indicated in FIG. 8 as “CAMS Addspace”)
III If that process establishes that it does lie in the assigned address space reserved by the Card Issuer for the VPA to create VCNs, the decision process effectively requests the transaction conditions for the relevant VCN from the network location in which they are stored. In the present example, that request is made by routing, at 850, the DPAN approval request to the CAMS. Approval of the request is returned by the CAMS at 860, accompanied by the transaction constraints in the form of provisioning conditions setting out the conditions 870 for authorisation of transactions using the DPAN.

If, by contrast, the decision process does establish that the card number in connection with which the approval request is made lies in an address space notified by the CAMS as reserved for the VPA, then the card number lies in the remaining address space managed by the Card Issuer (CI AddSpace) and the provisioning request is passed through at step 820 to the Card Issuer 820 for approval and provisioning.

In this manner it is possible to issue a transaction token (DPAN) on the basis of a Real Card Number (PAN); but it is likewise possible to issue a transaction token (DPAN) on the basis of a preceding token (VCN) where previously this was not possible.

It is noteworthy that according to this embodiment of the present invention, approval and provisioning of the request for the DPAN is undertaken by routing to the CAMS, whereas authorisation of payment requests pursuant to the approval provisioning conditions are made by process workflows within the Card Scheme which implement the authorisation conditions specified by the CAMS and on the basis of which approval was provided. This is in contrast to the conventional flow architecture where requests for approval and authorisation are both routed to the same entity.

In a further modification, the CAMS may operate to insert an additional provisioning stage following receipt of the forwarded request 850 for provisioning approval. This additional stage 880 involves the sending of an authentication challenge to the employee 210, based upon the data held by the CAMS in connection with the issue of the VCN upon which the request for the DPAN is based. The challenge may typically be in the form of the dispatch of a one time password to the cell phone number notified in connection with the original request for the VCN. The response to the challenge is therefore the return of this password by the Employee 210 to the CAMS to establish that the same cell phone number is being used in connection with the issue of the DPAN and therefore serves to establish that the VCN is still held and is being preferred by the same person to whom it was originally issued. This additional security stage provides a ‘step-up’ in provisioning in the DPAN approval process.

In some examples, the ability to support third party applications/systems can be provided. For example, third party applications can be provided with access to the system as described herein enabling them to create virtual payment cards for use by end users. Such virtual payment cards can be used as part of existing third party payment platforms, such as Apple Pay and Google Pay for example. For example, a third-party app can check if an issued virtual payment card is available for use in a third party payment platform or not. If so, the third party app can provide the end user account details (e.g., name, email, mobile number, call centre number and so on) in order to support provisioning. If the end user needs to be verified, the appropriate contact details for the user that was issued the card are thus available and the verification of the user can be performed on behalf of the third party application.

For example, a real world use case may involve a situation in which a flight of an end user is delayed. Typically, an airline may issue the end user with a voucher to be used at one or more hospitality venues at an airport. However, rather than an airline issuing a paper disruption voucher to spend to, e.g., delay, an end user can be prompted within an application of the Airline to, for example, “Add to Apple Wallet” a virtual card to Apple Pay/Google Pay, which may be used to pay in-store instead of a paper voucher. This is more secure, lower cost to the airline, and results in broader acceptance by merchants.

In another example, an insurance company may grant the claim of an end user and may then instantly issue a virtual card to be used to pay in-store or in-app to replace, e.g., white goods which were the subject of the claim. Again, this is secure, can be used to control which merchants are used. It also presents cost advantages to the insurance company.

According to an example, a degree of personalisation of a virtual payment card can be provided. For example, dependent on the virtual card number account range, or customer, terms and conditions that an end user accepts during a provisioning workflow (e.g., adding the card to the digital wallet) and personalised card imagery can be tailored. This allows card issuing partners to offer a more bespoke payment solutions and branding to customers. For example, if an airlines partners with a bank to issue virtual cards instead of paper vouchers, the T&Cs presented and accepted by the airline customer (i.e., the ned user) will be relative to the use case and the card art displayed can be bespoke branding for the airline and bank affinity programme.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, user equipment such as a smart device, e.g., a smart phone, a special purpose computer, an embedded processor or processors of other programmable data processing devices to realize the functions described in the description and diagrams. In particular, a processor or processing apparatus may execute the machine-readable instructions. Thus, modules of apparatus (for example, a module implementing a card scheme) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode. For example, the instructions may be provided on a non-transitory computer readable storage medium encoded with instructions, executable by a processor.

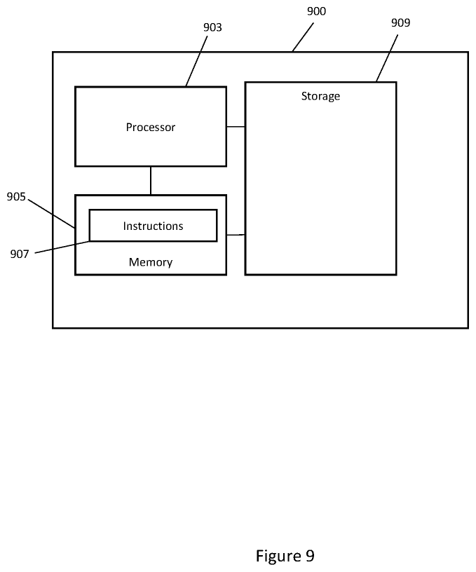

FIG. 9 is a schematic representation of a machine according to an example. The machine 900 can be, e.g., a system or apparatus, user equipment, or part thereof. The machine 900 comprises a processor 903, and a memory 905 to store instructions 907, executable by the processor 903. The machine comprises a storage 909 that can be used to store data representing an entity, a transaction, a data string or part thereof and so on as described above with reference to FIGS. 1 to 8 for example.

The instructions 907, executable by the processor 903, can cause the machine 900 to provide a primary data string to a customer, assign an address space within the third data field for use by a further party acting with the authority of the customer, such that (i) all third data values within the assigned address space are available for use in creating valid data strings and (ii) valid data strings having third data values which lie within the designated address space are subordinate data strings to the primary data string within a data hierarchy, establish constraints subject to which transactions using a given subordinate data string may be conducted and identifying to the accrediting agency, by reference to a range of values lying within the assigned address space, a location within the network of those transaction constraints, request a token having the prescribed data format and a valid checksum from the accrediting entity by submitting a token request that includes the given subordinate data string; parse the token request to identify the given subordinate data string and the location of the transaction constraints; request the transaction constraints from the location, and store the transaction constraints at the accrediting entity.

Accordingly, the machine 900 can implement a method for processing a transaction in a digital network using data strings to identify parties, the data strings having a prescribed format comprising first, second and third data fields and a checksum, whereby the value of first data field identifies an accrediting entity; the value of the second data field identifies an issuing entity acting as a settlement proxy for a customer; the value of the third data field identifies a customer; and the value of the checksum establishes the integrity of the data string.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer or software product, such as a non-transitory machine-readable storage medium, the computer software or product being stored in a storage medium and comprising a plurality of instructions, e.g., machine readable instructions, for making a computer device implement the methods recited in the examples of the present disclosure.

In some examples, some methods can be performed in a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

While various embodiments have been described and/or illustrated herein in the context of fully functional computing systems, one or more of these exemplary embodiments may be distributed as a program product in a variety of forms, regardless of the particular type of computer-readable-storage media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein. In addition, one or more of the modules described herein may transform data, physical devices, and/or representations of physical devices from one form to another.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

1. A method of processing a transaction in a digital network using data strings to identify parties, the data strings having a prescribed format comprising first, second and third data fields and a checksum, whereby the value of first data field identifies an accrediting entity; the value of the second data field identifies an issuing entity acting as a settlement proxy for a customer; the value of the third data field identifies a customer; and the value of the checksum establishes the integrity of the data string, the method comprising the steps of:
providing a primary data string to a customer;
assigning an address space within the third data field for use by a further party acting with the authority of the customer, such that (i) all third data values within the assigned address space are available for use in creating valid data strings and (ii) valid data strings having third data values which lie within the designated address space are subordinate data strings to the primary data string within a data hierarchy;
establishing constraints subject to which transactions using a given subordinate data string may be conducted and identifying to the accrediting agency, by reference to a range of values lying within the assigned address space, a location within the network of those transaction constraints;
requesting a token having the prescribed data format and a valid checksum from the accrediting entity by submitting a token request that includes the given subordinate data string;
parsing the token request to identify the given subordinate data string and the location of the transaction constraints;
requesting the transaction constraints from the location; and
storing the transaction constraints at the accrediting entity.

2. A method according to claim 1 further comprising the step of receiving at the accrediting entity, a request for authorisation of a transaction, the request including the token and data expressing conditions of the requested transaction; and
comparing the transaction conditions to the transaction constraints and, where the conditions lie within the constraints, passing the transaction request to the issuing entity.

3. A method according to claim 1 wherein the subordinate data string identifies an authorised user acting with the authority of the customer, and the step of requesting a token is initiated by the authorised user.

4. A method according to claim 3 wherein:
the transaction constraints are constraints applying to use of the subordinate data string by the authorised user and the transaction constraints are held at the location by a trusted administrator; and
the trusted administrator retains network contact data relating to the authorised user of the subordinate data string.

5. A method according to claim 4 further comprising the step, following the step of requesting the transaction constraints from the location and prior to storing the transaction constraints at the accrediting entity, of the trusted administrator dispatching an authentication challenge to the authorised user using the contact data.

6. A method according to claim 5 further comprising the step of receiving response data from the authenticating challenge and in response thereto of sending the transaction constraints to the accrediting agency for it to store.

7. A method of authorising a payment token request to enable processing a transaction in a digital network using data strings to identify parties, the data strings having a prescribed format comprising first, second and third data fields and a checksum, whereby the value of first data field identifies an accrediting entity; the value of the second data field identifies an issuing entity acting as a settlement proxy for a customer; the value of the third data field identifies a customer; and
the value of the checksum establishes the integrity of the data string, wherein a primary data string is provided to a customer; an address space within the third data field is assigned for use by a further party acting with the authority of the customer, such that (i) all third data values within the assigned address space are available for use in creating valid data strings and (ii) valid data strings having third data values which lie within the designated address space are subordinate data strings to the primary data string within a data hierarchy; constraints subject to which transactions using a given subordinate data string may be conducted are established and a location within the network of those transaction constraints is identified to the accrediting agency, by reference to a range of values lying within the assigned address space; a token having the prescribed data format and a valid checksum is requested from the accrediting entity by the submission of a token request that includes the given subordinate data string; the token request is parsed to identify the given subordinate data string and the location of the transaction constraints; and the transaction constraints are requested from the location, wherein the subordinate data string identifies an authorised user acting with the authority of the customer, and the step of requesting a token is initiated by the authorised user;
the method comprises the steps, performed by a trusted administrator of:
applying transaction constraints to use of the subordinate data string by the authorised user;
retaining the transaction constraints at the location; and
retaining network contact data relating to the authorised user of the subordinate data string;
following the request of the transaction constraints from the location and prior to storing the transaction constraints at the accrediting entity, dispatching an authentication challenge to the authorised user using the contact data; and
receiving response data from the authenticating challenge and in response thereto of sending the transaction constraints to the accrediting agency for it to store.

8. A machine-readable storage medium encoded with instructions for processing a transaction in a digital network using data strings to identify parties, the data strings having a prescribed format comprising first, second and third data fields and a checksum, whereby the value of first data field identifies an accrediting entity; the value of the second data field identifies an issuing entity acting as a settlement proxy for a customer; the value of the third data field identifies a customer; and the value of the checksum establishes the integrity of the data string, the instructions executable by a processor, whereby to cause the processor to:
provide a primary data string to a customer;
assign an address space within the third data field for use by a further party acting with the authority of the customer, such that (i) all third data values within the assigned address space are available for use in creating valid data strings and (ii) valid data strings having third data values which lie within the designated address space are subordinate data strings to the primary data string within a data hierarchy;
establish constraints subject to which transactions using a given subordinate data string may be conducted and identifying to the accrediting agency, by reference to a range of values lying within the assigned address space, a location within the network of those transaction constraints;
request a token having the prescribed data format and a valid checksum from the accrediting entity by submitting a token request that includes the given subordinate data string;
parse the token request to identify the given subordinate data string and the location of the transaction constraints;
request the transaction constraints from the location; and
store the transaction constraints at the accrediting entity.

9. The machine-readable storage medium as claimed in claim 8, further comprising instructions executable by the processor, whereby to cause the processor to:
transmit or receive data representing end user information; and
on the basis of the data, verify the end user.

10. The machine-readable storage medium as claimed in claim 9, further comprising instructions executable by the processor, whereby to cause the processor to:
generate data representing a virtual payment card for an end user.

11. The machine-readable storage medium as claimed in claim 8, further comprising instructions executable by the processor, whereby to cause the processor to:
generate data representing a bespoke set of terms and conditions for an end user.

12. A data structure for a data string, the data string configured to enable a party to be identified in a transaction in a digital network, the data structure comprising:
first, second and third data fields and a checksum data field, wherein:
the first data field is configured to comprise a first data value to identify an accrediting entity;
the second data field is configured to comprise a second data value to identify an issuing entity acting as a settlement proxy for a customer;
the third data field is configured to comprise a third data value to identify a customer; and
the checksum data field is configured to comprise checksum data to attest to the integrity of the data string.

13. A method according to claim 2 wherein the subordinate data string identifies an authorised user acting with the authority of the customer, and the step of requesting a token is initiated by the authorised user.

14. A method according to claim 13 wherein:
the transaction constraints are constraints applying to use of the subordinate data string by the authorised user and the transaction constraints are held at the location by a trusted administrator; and
the trusted administrator retains network contact data relating to the authorised user of the subordinate data string.

15. A method according to claim 14 further comprising the step, following the step of requesting the transaction constraints from the location and prior to storing the transaction constraints at the accrediting entity, of the trusted administrator dispatching an authentication challenge to the authorised user using the contact data.

16. A method according to claim 15 further comprising the step of receiving response data from the authenticating challenge and in response thereto of sending the transaction constraints to the accrediting agency for it to store.
